(19) United States
(12) Patent Application Publication
(10) Pub. No.: US 2013/0006711 A1
(43) Pub. Date: Jan. 3, 2013

(54) SYSTEM AND METHOD FOR ENHANCING PRODUCTIVITY OF SALES AND MARKETING OPERATIONS OF PHARMACEUTICAL COMPANIES

(75) Inventors: Kamal BISWAS, Edison, NJ (US); S. Rochan, Bangalore (IN); Sandeep RAJU, Zurich (CH)

(73) Assignee: INFOSYS LIMITED, Bangalore (IN)

(21) Appl. No.: 13/232,225

(22) Filed: Sep. 14, 2011

(30) Foreign Application Priority Data
Jun. 30, 2011 (IN) 2214/CHE/2011

(51) Int. Cl. G06Q 30/02

(52) U.S. Cl. 705/7.33

(57) ABSTRACT

A system and method for enhancing productivity of sales and marketing operations of pharmaceutical companies is provided. The method includes collecting information pertaining to pharmaceutical sales and marketing operations from all available sources. The method further includes processing the collected information to identify a plurality of market segments, to determine performance of sales representatives, and to determine impact of sales and marketing efforts. Further, the method includes generating marketing content based on the processed information. Marketing content is generated based on feedback on previous sales and marketing materials, specific questions asked during sales interactions and new research on pharmaceutical medicines. Ultimately, pharmaceutical sales and marketing campaigns are generated based on the generated marketing content.

### FIELD OF INVENTION

The present invention generally relates to sales and marketing operations of pharmaceutical companies. More specifically, the present invention relates to enhancing productivity of sales and marketing operations of pharmaceutical companies using feedback-driven marketing analytics.

### BACKGROUND OF THE INVENTION

Currently, the pharmaceutical industry is facing significant issues in revenue growth, which may be primarily attributed to inconsistent results in research and development, expiry of patents, and diminishing sales productivity. Moreover, there has been a considerable fall in the number of sales representatives in various pharmaceutical companies. The fall in the number of sales representatives may be directly attributed to issues of revenue growth, the change in outlook of various pharmaceutical companies in the recent years, and the change in perspective of physicians' about sales representatives.

Today, pharmaceutical companies are trying to achieve revenue growth with lesser number of sales representatives. To this intent, pharmaceutical companies are employing up-to-date marketing models and using Information Technology (IT) tools such as, but not limited to, sales force automation and Customer Relationship Management (CRM) tools, to enhance revenues.

As a result of the usage of IT tools, there has been a drift from the standard paper based demonstrations to physicians' to tablet based presentations to the physicians. The initiative to move to tablet based i.e. computer/laptop based presentations has also enabled collection of comprehensive information on pharmaceutical sales and marketing, and to utilize the collected information to devise improved marketing models by understanding the requirement of the customers i.e. physicians and patients.

The abovementioned IT tools have the following limitations. Each IT tool is designed to address one functional area such as, pharmaceutical sales data analysis, sales representative performance analysis, physicians' perspective analysis, pharmaceutical product campaign management, and patient compliance. This prohibits collection of data pertaining to the entire loop starting from developing sales and marketing materials to determining the impact of sales and marketing materials on actual sales. Further, as the information collected from various tools is siloed, the collected information remains unstructured and in general redundant. This leads to uncoordinated sales and marketing material development, which in turn results in poor performance of sales representatives. In addition, the IT tools are brand-centric, and are developed to address specific needs of select pharmaceutical companies. Therefore, the requirements of customers i.e. physicians' and patients' requirements are not particularly addressed.

Consequently, there is a need for a system and method for deriving comprehensive feedback information related to pharmaceutical sales and marketing operations from all available sources. Further, there is a need to enhance productivity of sales and marketing operations of pharmaceutical companies based on content of feedback information.

### SUMMARY OF THE INVENTION

A system and method for enhancing productivity of sales and marketing operations of a pharmaceutical organization is provided. The system includes an input module configured to collect data pertaining to the sales and marketing operations from one or more data sources. The system further includes a customer segmentation module configured to form one or more customer segments, wherein each customer segment comprises a plurality of individuals who are similar in specific ways relevant to marketing such as age, gender, medical history, profiles and patient compliance. Further, the system includes a processing module configured to receive segmentation information from the customer segmentation module and further configured to process the information for evaluating performance of sales and marketing operations of the pharmaceutical organization. A marketing decision and content management module is configured to generate marketing content for one or more market segments and to modify existing marketing content for driving sales and marketing operations of the organization. The system also includes a campaign management module configured to generate and deploy the campaigns, and track the impact of campaigns.

In various embodiments of the present invention, the one or more data sources are web-based information channels, call centers, meetings and convocations, third-party information sources of syndicated data and face-to face interactive sessions with physicians. The web-based information channels may comprise one or more websites such as company websites, hospital websites, product and disease websites, online social and professional networks related to pharmaceutical products, pharmaceutical questionnaires and surveys, and web conferences. Call centers may comprise customer contact centers for obtaining feedback from physicians related to pharmaceutical drugs and other medicinal products. Third-party information sources of syndicated data include external vendors or agencies providing syndicated pharmaceutical market research information, market segmentation information and marketing materials.

In various embodiments of the present invention, one or more application programming interfaces are used to extract information from the one or more websites comprising information related to pharmaceutical products and services.

In various embodiments of the present invention, data collected during interactive sessions comprises details relating to presented product content, content viewing times, physicians' feedback on content, order in which various sections of the product content is viewed and any additional information associated with the product which is sought by a physician.

In various embodiments of the present invention, the input module is configured to receive data pertaining to the sales and marketing operations from one or more elements. The one or more elements comprises a web repository configured to receive and store information collected by web-based information channels, a call feedback repository configured to receive and store information regarding usage and efficacy of pharmaceutical drugs obtained as feedback from physicians through direct calling or face-to-face meetings and an external information repository configured to receive and store information from third-party information sources such as market research firms and research organizations.

In various embodiments of the present invention, the system of the invention comprises a marketing operational data store configured to integrate data from the one or more data sources, to perform predetermined operations on the integrated data and forward the integrated data to a data warehouse, wherein the predetermined operations comprises analyzing the data, resolving redundancy in data, and checking against predetermined business rules for data integrity. The system further comprises a marketing data warehouse configured to receive the integrated data from the marketing operational data store and further configured to identify historical trends in aggregated data, individual physician records, and interactions with individual sales representatives.

In various embodiments of the present invention, the system of the invention includes a marketing planning module configured to implement software workflows for facilitating the generation of marketing content, wherein the software workflows are utilized by the marketing decision and content management module for generating and modifying marketing content.

In various embodiments of the present invention, the system of the invention includes a marketing content repository configured to store generated content for customer segments, wherein the stored content comprises historical data related to sales and marketing materials, further wherein the marketing decision and content management module is configured to generate segment-specific content based on legacy data stored in the repository.

In various embodiments of the present invention, the method of the invention includes the steps of collecting information pertaining to sales and marketing operations from one or more data sources, wherein the information is collected from a plurality of information channels and processing the collected information to identify one or more market segments. Further, the method includes determining performance of sales and marketing operations for the one or more market segments and generating marketing content based on the determined performance of sales and marketing operations. Finally, the method includes generating sales and marketing campaigns based on the generated content.

In various embodiments of the present invention, the method includes deploying the generated sales and marketing campaigns.

In an embodiment of the present invention, the plurality of information channels are web-based information channels, call centers, meetings and convocations, and third-party information sources of syndicated data.

In an embodiment of the present invention, performance of sales and marketing operations is determined by establishing segment-wise performance of sales representatives. In another embodiment of the present invention, the performance of sales and marketing operations is determined by studying change in prescribing habits of pharmaceutical drugs in specific market segments.

### BRIEF DESCRIPTION OF THE ACCOMPANYING DRAWINGS

The present invention is described by way of embodiments illustrated in the accompanying drawings wherein:

FIG. 1 illustrates block diagram of a system for implementing productivity enhancement of pharmaceutical sales and marketing operations; and

FIG. 2 illustrates a flowchart depicting method steps for implementing productivity enhancement of pharmaceutical sales and marketing operations.

### DETAILED DESCRIPTION OF THE INVENTION

The present invention provides a system and computer-implemented method for enhancing productivity of pharmaceutical sales and marketing operations. In various embodiments of the present invention, the method comprises first collecting information pertaining to pharmaceutical sales and marketing operations from all available sources. The computer-implemented method further comprises processing the collected information to identify a plurality of market segments of the pharmaceutical market, determine performance of sales representatives, and to determine impact of sales and marketing efforts. In addition, the computer-implemented method comprises generating pharmaceutical sales and marketing content targeting specific customer segments. Thereafter, marketing campaigns use the newly generated content to have maximum impact. Further, system and method of the present invention enables tracking the impact of the generated campaigns

The disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

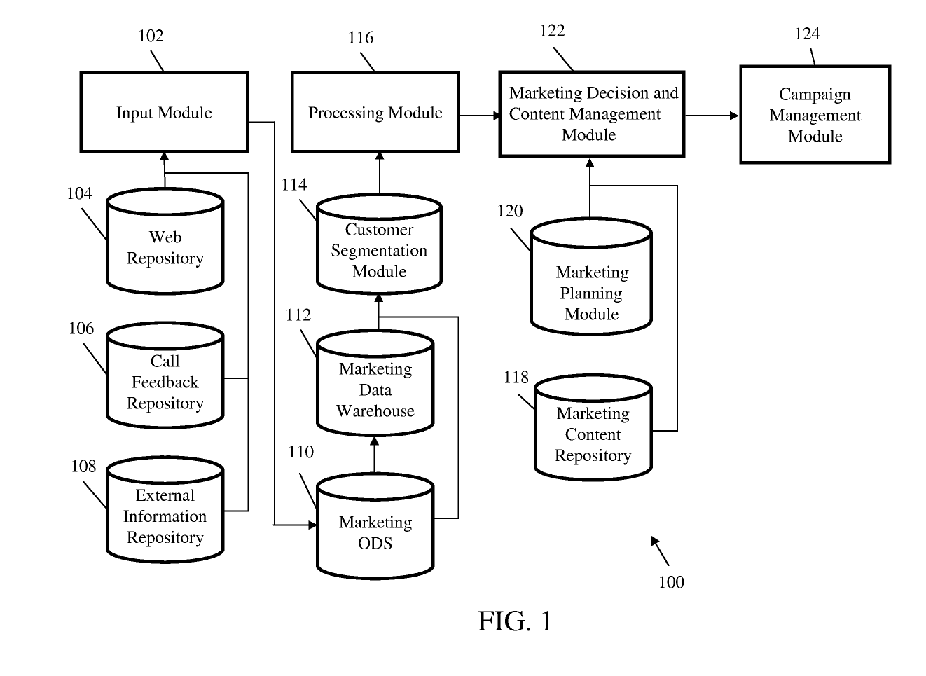

FIG. 1 illustrates block diagram of a system for implementing productivity enhancement of pharmaceutical sales and marketing operations. Various embodiments of the present invention can be implemented by organizations for achieving productivity enhancement of pharmaceutical sales and marketing operations. The present invention enables deriving feedback related to pharmaceutical sales and marketing operations of an organization from all available information channels. Received feedback content is then managed using a technology platform. Managing feedback content includes performing analytics on the content for defining market segments based on diversity of pharmaceutical products as well as the diversity of the customer base (e.g. different kinds of physicians—GPs, Specialists, etc.) Following the definition of market segments, systems and methods of the present invention enable creation of customized marketing content for individual market segments. Based on the customized marketing content, specific market campaigns are created, modified and implemented for achieving optimum productivity in sales and marketing operations.

As illustrated in the figure, system 100 of the invention comprises an input module 102, a web repository 104, a call feedback repository 106, an external information repository 108, a marketing Operational Data Store (ODS) 110, a marketing data warehouse 112, a customer segmentation module 114, a processing module 116, a marketing content repository 118, a marketing planning module 120, a marketing decision, content management module 122, a campaign management module 124 and a content delivery module 126.

In various embodiments of the present invention, input module 102 is configured to collect information pertaining to pharmaceutical sales and marketing operations from various data sources. In various embodiments of the present invention, information pertaining to pharmaceutical sales and marketing operations comprises, but is not limited to, information related to sales representatives and physicians, information related to sales and marketing materials being used by sales representatives, information related to sales and marketing efforts, feedback of sales representatives and physicians' on sales and marketing efforts, data related to actual and forecasted pharmaceutical product sales, data related to usage of pharmaceutical products etc. Multiple pharmaceutical channels utilized for obtaining information may include, but are not limited to, pharmaceutical sales channels, information from patients, healthcare companies, government, web-based information channels etc. Data obtained is then consolidated and analyzed for understanding customer segmentation and performance of sales force in the pharmaceutical sales process. Based on the analysis, marketing decisions are made on customer segments, individual physicians and sales force planning.

In an exemplary embodiment of the present invention, plurality of information channels are used for collecting information which include, but are not limited to, web-based information channels, call centers, meetings and convocations and third-party information sources of syndicated data. Web-based information channels may comprise company websites, hospital websites, product and disease websites, social and professional networks related to pharmaceutical products, pharmaceutical questionnaires/surveys, web conferences and so forth. Call centers may comprise call centers operated by pharmaceutical companies, hospitals for obtaining feedback from physicians related to pharmaceutical drugs and other medicinal products etc. Meetings and convocations may comprise meetings and convocations organized by various pharmaceutical companies, hospitals, universities and so forth. Third-party information sources of syndicated data may comprise external vendors or agencies providing syndicated pharmaceutical market research information, market segmentation information, marketing materials and so forth.

In an embodiment of the present invention, input module 102 is configured to collect information through web-based information channels. One or more application programming interfaces are used to extract information from one or more websites comprising information related to pharmaceutical products and services. Further, web-based information channels may include web-based interactions such as sessions hosted over the internet, wherein physicians and health service providers view different parts of the marketing content to enhance their understanding of the products. In some cases, this could be done with the assistance of the sales representatives, either remotely or face-to-face. Data collected during the interactive sessions may comprise details relating to presented product content, content viewing times, physicians' feedback on content and order in which various sections of the product content is viewed. Data collected during interactive sessions may also include any additional information associated with the product which is sought by a physician.

In another embodiment of the present invention, input module 102 is further configured to collect information during web conferences between sales representatives and physicians over a telecommunication network. Details collected during web conferences may comprise presented content related to pharmaceutical products, physicians' feedback on pharmaceutical products, and so forth.

Information collected by web-based information channels is stored in the web repository 104. In an exemplary embodiment of the present invention, web repository 104 is a database configured to enable digital storage of information. The database may be one of, but not limited to, a relational database, an operational database, an analytical database, an external database, a navigational database and a document-oriented database.

In an embodiment of the present invention, information data stored in the web repository 104 is in a format wherein the data is classified in terms of product segments. For example, the information collected may be used to categorize products into therapeutic areas, such as anticancer, antidiabetic, cardiovascular, ophthalmological, immunological etc. Further, within the therapeutic areas, pharmaceutical product data is sub-categorized based on medicine types.

In certain embodiments of the present invention, one of the data sources used to obtain information regarding usage and efficacy of pharmaceutical drugs include obtaining feedback from physicians through direct calling or face-to-face meetings. Information collected through the aforementioned means is manually stored in call feedback repository 106 through a user interface. In an exemplary embodiment of the present invention, call feedback repository 106 is a database configured to enable digital storage of information.

In other embodiments of the present invention, input module 102 is configured to collect information through third-party information sources of syndicated data. For example, input module 102 may collect pharmaceutical sales and marketing reports from third-party vendors. Third party vendors may include market research firms, research organizations, etc. Information collected from third-party information sources is stored in external information repository 108. Database may be one of, but not limited to, a relational database, an operational database, an analytical database, an external database, a navigational database and a document oriented database.

In various embodiments of the present invention, information collected from the web repository 104, call feedback repository 106 and external information repository 108 are collected and stored by the input module 102. Marketing Operational Data Store (ODS) 110 is an integrated database configured to integrate data obtained from input module 102 as well as data from the web repository 104, call feedback repository 106 and external information repository 108. Marketing ODS 110 is configured to perform predetermined operations on the integrated data, and forward the processed integrated data to marketing data warehouse 112. In an embodiment of the present invention, Marketing ODS uses an Extract, Transform and Load (ETL) process for extracting data from the web repository 104, call feedback repository 106 and external information repository 108 and for loading data into marketing data warehouse 112. Following the extraction and transformation of data derived from various sources, operations may be performed on the integrated data that may include analyzing the data, resolving redundancy in data, and checking against predetermined business rules for data integrity. In addition, Marketing ODS 112 is configured to store the integrated data for a predetermined interval of time. Data forwarded by Marketing ODS 110 to marketing data warehouse 112 is stored by the marketing data warehouse 112. Thus, marketing data warehouse 112 stores real time feedback data as well as legacy data related to pharmaceutical products obtained from interactions with physicians, sales personnel, patients and other sources. In various embodiments of the present invention, marketing data warehouse 114 is configured to identify historical trends in aggregated data, individual physician records, and interactions with individual sales representatives.

Data from Marketing ODS 110 and marketing data warehouse 112 is utilized by customer segmentation module 114 to distinguish customer segments. Customer segmentation includes dividing customer base into multiple groups of individuals who are similar in specific ways relevant to marketing such as age, gender, medical history, profiles, patient compliance, etc. In various embodiments of the present invention, for the purpose of distinguishing customer segments, product segmentation information as well as information related to pharmaceutical sales and marketing operations is utilized by customer segmentation module 114. In various embodiments of the present invention, product segment classification is used for identifying and creating customer segments which are then utilized to create and execute market campaigns. Examples of customer segments may include segments based on pharmaceutical product usage by customers, segments based on age of customers, segments based on customer gender, segments based on customer profile, segments based on customer medical history etc.

Processing module 116 is configured to receive segmentation information from customer segmentation module 114 and then process the information. Processing the information includes determining performance of sales representatives with respect to geographical areas, determining performance of sales representatives with respect to customer segments, assessing productivity of sales and marketing efforts for identified customer segments etc. For the purpose of processing segmentation information, Processing module 116 firstly identifies one or more market segments. In an embodiment of the present invention, performance of sales representatives may be indicated by change in prescribing habits of a particular drug in a particular market segment, where the sales representative gave product demonstrations to physicians' of that market segment. In another embodiment of the present invention, performance of sales representatives is determined based on information collected on pharmaceutical product sales and physicians' perspective on the sales and marketing materials. In yet another embodiment of the present invention, the impact of the sales and marketing efforts is determined based on change in the sales of pharmaceutical products after promotion of the products in predetermined market segments.

In an embodiment of the present invention, for determining performance of sales representatives, external software tools may be used in identifying prescription pattern at a physician level within various geographical areas. The tools may be configured to identify difference between prescribing habits prior to a marketing interaction or event and after the marketing interaction or event. For identifying the effectiveness of sales and marketing efforts, in various embodiments of the preset invention, the tools are configured to identify important navigation paths and also material which is not used during interactions.

Following the processing of information, data related to productivity of sales and marketing operations is saved in the form of reports. In various embodiments of the present invention, one or more reports are generated which include, but are not limited to, report on identified customer segments, performance reports of pharmaceutical sales personnel and sales groups, pharmaceutical product-wise sales reports, geography-wise sales reports and assessment reports associated with sales and marketing efforts. Further, processing module 116 is configured to store reports related to web based interactions of sales representatives with physicians, web conferences, call feedback information between sales representatives and physicians etc.

In an embodiment of the present invention, marketing decision and content management module 122 is configured to create new marketing content for driving pharmaceutical sales and marketing operations of an organization. In another embodiment of the present invention, marketing decision and content management module 122 is configured to modify existing marketing content for driving pharmaceutical sales and marketing operations of the organization.

Generating marketing content includes generating information for facilitating marketing and sales operations of pharmaceutical products. In an exemplary embodiment of the present invention, generating marketing content includes generating sales and marketing materials for introduction of a new pharmaceutical product based on information pertaining to physicians', performance of the drugs during clinical trials and post market introduction. Further, the content is based on feedback on previous sales and marketing materials from physicians' and their information needs, and also understanding what other new content is available to share with the physicians. In another embodiment of the present invention, generating marketing content includes generating customized sales and marketing materials for specific customer segments. For example, customized sales and marketing materials may be generated for demonstration to cancer specialists, general practitioners, heart specialists, health insurance companies, etc. Marketing content is generated based on information received from processing module 116. For the purpose of generating marketing content, information provided by Marketing Planning Module 120 is utilized by marketing decision and content management module 122. Marketing Planning Module 120 includes software workflows for generating marketing content based on one or more input parameters.

In an embodiment of the present invention, using templates of software workflows from Marketing Planning Module 120 and feedback information of pharmaceutical sales and marketing operations from processing module 116, marketing content is generated by Marketing Decision and Content Management Module 122. In various embodiments of the present invention, Marketing decision and content management module 122 is configured to decide on software workflows using appropriate approvals. An assessment of sales and marketing reports triggers requests to create new or modify existing content. The request would give information around the reports and reference existing content (either related to a campaign or even outside of a campaign). Once new material is approved, the availability of new material is made known to brand managers and specific sales representatives to incorporate it into their marketing planning In an embodiment of the present invention, a brand manager can enforce the new material into marketing planning of all sales representatives. In an embodiment of the present invention, the generated marketing content is provided to a Marketing Content Repository 118.

Marketing Content Repository 118 is configured to store generated content for customer segments. The stored content may comprise historical data related to sales and marketing materials, such as presentations, marketing manuals, segment-wise marketing materials etc. Marketing decision and content management module 122 may use legacy data from Marketing Content Repository 118 for generating content for specific segments. In an exemplary embodiment of the present invention, market content repository 122 is a database configured to enable digital storage of information. Further, the database may be one of, but not limited to, a relational database, an operational database, an analytical database, an external database, a navigational database and a document-oriented database.

In an embodiment of the present invention, Campaign management module 124 is configured to manage pharmaceutical sales and marketing campaigns. In an embodiment of the present invention, managing pharmaceutical sales and marketing campaigns comprises generating pharmaceutical sales and marketing campaigns, deploying the generated campaigns, and tracking the impact of the generated campaigns. A campaign may be a campaign corresponding to type of pharmaceutical products. Another campaign may be corresponding to specific customer segments where they have limited knowledge of the product. Yet another campaign may be corresponding to geographical areas where the products are applicable. Yet another campaign may be associated with a specific age group in general and an age specific marketing material can be used for employing the campaign. In an exemplary embodiment of the present invention, managing campaigns also comprise updating the campaigns based on real-time data gathered from the plurality of information channels.

In another embodiment of the present invention, campaign management module 124 is configured to track results and performance of the generated marketing campaign. For example, after a marketing campaign for promotion of a new cancer drug is generated, information pertaining to adaptation and impact of the marketing campaign may be tracked.

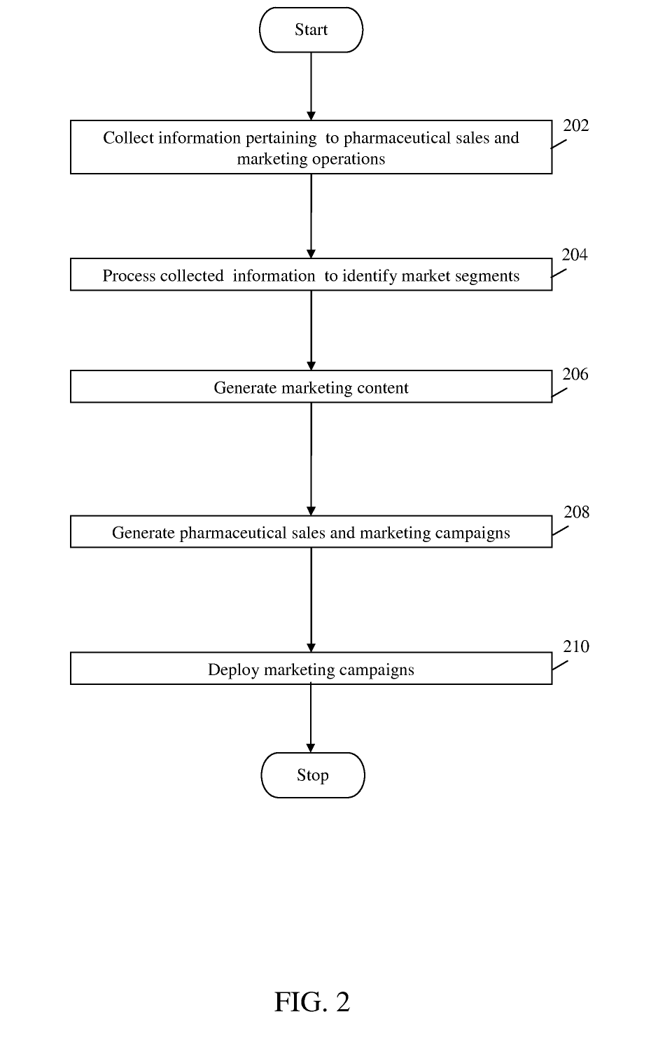

FIG. 2 illustrates a flowchart depicting method steps for implementing productivity enhancement of pharmaceutical sales and marketing operations.

As shown in the figure, at step 202, information pertaining to pharmaceutical sales and marketing operations is collected from all available sources. In an embodiment of the present invention, the information is collected from a plurality of information channels. The plurality of information channels comprise, but are not limited to, web-based information channels, call centers, meetings and convocations, and third-party information sources of syndicated data.

In various embodiments of the present invention, information pertaining to pharmaceutical sales and marketing operations comprises, but is not limited to, information related to sales representatives and physicians, information related to sales and marketing materials being used by sales representatives, information related to sales efforts, feedback of sales representatives and physicians' on sales and marketing efforts, and the actual and forecasted pharmaceutical product sales.

At step 204, the collected information is processed to identify a plurality of market segments, determine performance of sales representatives, and determine impact of sales and marketing efforts. In various embodiments of the present invention, the plurality of market segments are identified by analyzing the information collected on physicians. Information collected on physicians comprises, but is not limited to, medical specialty of physicians', attitudinal information of physicians', pharmaceutical product preferences of physicians', demographic data about physicians' and pharmaceutical companies. Examples of market segments include, but are not limited to, geography based cancer specialist segment, cardiology expert segment, neurology expert segment, segments showing/not showing preference towards alternate and new pharmaceutical products, and so forth.

In an embodiment of the present invention, the performance of sales representatives is determined based on the information collected on pharmaceutical product sales and physicians' perspective on the sales and marketing materials. For example, the performance of a sales representative may be indicated by the change in revenue generated through a particular drug in a particular market segment, where the sales representative gave product demonstrations to the physicians' of that market segment.

In an embodiment of the present invention, the impact of the sales and marketing efforts is determined based on the change in the sales of the pharmaceutical products after promotion of the pharmaceutical products in predetermined market segments.

At step 206, marketing content is generated based on the processed information. Marketing content may be generated based on feedback on previous sales and marketing materials, specific questions asked during sales interactions, new research on a drug, and so forth.

At step 208, pharmaceutical sales and marketing campaigns are generated based on the generated marketing content. Examples of campaigns generated may comprise new pharmaceutical product promotional campaigns, campaigns to gather deeper insights on existing pharmaceutical products and so forth.

At step 210, the generated campaigns are deployed, and the results and performance of the generated campaigns are tracked. In an exemplary embodiment of the present invention, deploying the generated campaigns comprises implementing and tracking the steps of the generated campaigns. For example, deploying a new pharmaceutical product promotional campaign may comprise providing generated sales and marketing materials to sales representatives, demonstrations of the generated sales and marketing materials to physicians', collecting feedback on the generated sales and marketing materials from sales representatives and physicians, tracking revenues generated from the new pharmaceutical product, calculating change in revenues after demonstration of the generated sales and marketing materials to physicians' and so forth. In an embodiment, the system and method of the present invention employs a campaign management module for publishing updated sales and marketing materials to various channels such as product websites, internal database used by sales representatives etc.

While the exemplary embodiments of the present invention are described and illustrated herein, it will be appreciated that they are merely illustrative. It will be understood by those skilled in the art that various changes in form and detail may be made therein without departing from or offending the spirit and scope of the invention.

What is claimed is:

1. A system for implementing productivity enhancement of sales and marketing operations of a pharmaceutical organization, the system comprising:
an input module configured to collect data pertaining to the sales and marketing operations from one or more data sources;
a customer segmentation module configured to form one or more customer segments, wherein each customer segment comprises a plurality of individuals who are similar in specific ways relevant to marketing such as age, gender, medical history, profiles and patient compliance;
a processing module configured to receive segmentation information from the customer segmentation module and further configured to process the information for evaluating performance of sales and marketing operations of the pharmaceutical organization;
a marketing decision and content management module configured to generate marketing content for one or more market segments and to modify existing marketing content for driving sales and marketing operations of the organization; and
a campaign management module configured to generate and deploy the campaigns, and track the impact of campaigns.

2. The system of claim 1, wherein the one or more data sources comprises web-based information channels, call centers, meetings and convocations, third-party information sources of syndicated data and face-to face interactive sessions with physicians.

3. The system of claim 2, wherein the web-based information channels comprises one or more websites such as company websites, hospital websites, product and disease websites, online social and professional networks related to pharmaceutical products, pharmaceutical questionnaires and surveys, and web conferences.

4. The system of claim 3, wherein one or more application programming interfaces are used to extract information from the one or more websites comprising information related to pharmaceutical products and services.

5. The system of claim 2, wherein call centers comprise customer contact centers for obtaining feedback from physicians related to pharmaceutical drugs and other medicinal products.

6. The system of claim 2, wherein third-party information sources of syndicated data comprises external vendors or agencies providing syndicated pharmaceutical market research information, market segmentation information and marketing materials.

7. The system of claim 2, wherein data collected during interactive sessions comprises details relating to presented product content, content viewing times, physicians' feedback on content, order in which various sections of the product content is viewed and any additional information associated with the product which is sought by a physician.

8. The system of claim 1, wherein the input module is configured to receive data pertaining to the sales and marketing operations from one or more elements, the one or more elements comprising:
a web repository configured to receive and store information collected by web-based information channels;
a call feedback repository configured to receive and store information regarding usage and efficacy of pharmaceutical drugs obtained as feedback from physicians through direct calling or face-to-face meetings; and
an external information repository configured to receive and store information from third-party information sources such as market research firms and research organizations.

9. The system of claim 1 further comprising:
a marketing operational data store configured to integrate data from the one or more data sources, to perform predetermined operations on the integrated data and forward the integrated data to a data warehouse, wherein the predetermined operations comprises analyzing the data, resolving redundancy in data, and checking against predetermined business rules for data integrity; and
a marketing data warehouse configured to receive the integrated data from the marketing operational data store and further configured to identify historical trends in aggregated data, individual physician records, and interactions with individual sales representatives.

10. The system of claim 1 further comprising:
a marketing planning module configured to implement software workflows for facilitating the generation of marketing content, wherein the software workflows are utilized by the marketing decision and content management module for generating and modifying marketing content; and
a marketing content repository configured to store generated content for customer segments, wherein the stored content comprises historical data related to sales and marketing materials, further wherein the marketing decision and content management module is configured to generate segment-specific content based on legacy data stored in the repository.

11. A method for implementing productivity enhancement of sales and marketing operations of a pharmaceutical organization, the method comprising:
collecting information pertaining to sales and marketing operations from one or more data sources, wherein the information is collected from a plurality of information channels;
processing the collected information to identify one or more market segments;
determining performance of sales and marketing operations for the one or more market segments;
generating marketing content based on the determined performance of sales and marketing operations; and
generating sales and marketing campaigns based on the generated content.

12. The method of claim 11 further comprising deploying the generated sales and marketing campaigns.

13. The method of claim 11, wherein the plurality of information channels are web-based information channels, call centers, meetings and convocations, and third-party information sources of syndicated data.

14. The method of claim 11, wherein performance of the sales and marketing operations is determined by establishing segment-wise performance of sales representatives.

15. The method of claim 11, wherein the performance of sales and marketing operations is determined by studying change in prescribing habits of pharmaceutical drugs in specific market segments.
